(19) United States
(12) Patent Application Publication
(10) Pub. No.: US 2017/0165531 A1
(43) Pub. Date: Jun. 15, 2017

(54) BALL HOLDER FOR CARRYING AND DRYING A BALL HELD THEREIN

(71) Applicant: Marirose Charlene Lynch, Eastham, MA (US)

(72) Inventor: Marirose Charlene Lynch, Eastham, MA (US)

(21) Appl. No.: 15/442,065

(22) Filed: Feb. 24, 2017

Related U.S. Application Data
(63) Continuation-in-part of application No. 14/701,211, filed on Apr. 30, 2015.
Application No. 14/701,211 is a continuation-in-part of application No. 29/564,379, filed on May 12, 2016.
Application No. 29/564,379 is a continuation-in-part of application No. 29/523,562, filed on Apr. 10, 2015, now Pat. No. D759969.
(60) Provisional application No. 62/118,968, filed on Feb. 20, 2015.

(51) Int. Cl. A63B 47/04; B65D 43/22; A01K 27/00; B65D 47/32; B65D 6/00; A45F 5/02; B65D 8/00; B65D 43/16

(52) U.S. Cl. CPC A63B 47/04; B65D 11/02; B65D 43/22; B65D 43/165; B65D 47/32; B65D 11/20; A45F 5/021; A01K 27/008; A63B 2047/043

(57) ABSTRACT

A ball holder includes a first and second hollow hemispherical shell, each having a plurality of apertures therein. Each hemispherical shell includes a respective hinge part, and, diametrically opposed therefrom, a respective closure element. The first and second hinge parts are connected with each other, enabling turning the first or the second hemispherical shell relative to each other to open or close the ball holder. The first and second closure elements are aligned when the ball holder is closed permitting engagement with a releasable lock therethrough. The ball holder includes a plurality of protuberances spaced apart along internal surfaces of the hemispherical shells. The protuberances separate a ball held within the ball holder from the internal surfaces of the shells, and form discrete contact points to reduce surface contact areas of the ball with the internal surface for effectively drying the ball carried by the ball holder.

### CROSS REFERENCE TO RELATED APPLICATION

This application is a continuation-in-part of patent application No. 14/701,211, filed Apr. 30, 2015, which claims the benefit under 35 USC 119(e) of provisional patent application Ser. No. 62/118,968, filed Feb. 20, 2015; and this application is also a continuation-in-part of patent application No. 29/564,379, filed May 12, 2016, which is a continuation-in-part of patent application No. 29/523,562, filed Apr. 10, 2015, now U.S. Pat. No. D759,969. All parent applications are hereby incorporated by reference in their entireties.

### FIELD OF INVENTION

The present invention relates to ball holders, and particularly relates to a ball holder for carrying a ball by a person or a pet and for effectively drying a ball held therein if the ball becomes wet after use.

### BACKGROUND OF THE INVENTION

Devices for the holding of a tennis ball and, to a lesser extent, a golf ball, for the general purpose of keeping tennis balls and the like in a convenient location until such time that their use, whether as a tennis ball or for the entertainment of a pet such as a dog, is needed, has long existed in the art. That is, the prior art known to the inventor includes U.S. Pat. No. 4,061,256 (1977) to Beer et al, entitled Tennis Ball Holder To Be Worn On The Arm. Devices of the category of Beer do not provide any particular function in the drying of a ball that has become wet or saturated and, as such, if a wet tennis ball is inserted into the structure of Beer, moisture will drip therefrom and otherwise render it uncomfortable and inconvenient to use in the contemplated application.

U.S. Pat. No. 4,413,762 (1983) to Carini, entitled Game Ball Holder, teaches a special-purpose strap or holding means for integration into a garment such as tennis shorts or a tennis skirt and, as such, serves largely the same limited purpose as Beer above, that is, it is not suitable for use with a ball which is damp or moist. In fact, it is less suitable than Beer in that the tennis garment into which the ball holding means is integrated will itself become wet due to direct contact with the ball.

U.S. Pat. No. 4,836,427 (1989) to McManus, teaches a so-called Tennis Utility Belt which, fundamentally, relates to a belt placed about the waist of a tennis player and which includes a plurality of elastic tennis ball retention cages attached thereto. However, by encirclement of the waist by the tennis utility belt, the tennis balls, if wet or moist, will affect the tennis garment worn by the player thereby eventually causing discomfort and, actually, at a level which is a multiple of that in the case of Carini, discussed above.

On the other hand, a plastic container may be used to store or carry a tennis ball or other balls, however, lack of proper ventilation in such a container prevents drying of the tennis ball when it becomes wet, which will lead development of odor and growth of microbials on the tennis ball. Moreover, even if the plastic container includes openings, pressing of a wet surface of a tennis ball on the interior wall of the container prevents exposure of the wet surface to air and inhibits drying of the wet surface.

In view of the above, there is a need of a ball holder that can be used to carry or store a ball, such as tennis ball, softball, baseball, golf ball, ping pong ball, rubber ball, or other balls, for sports activities or a use as a dog toy whether or not the ball becomes wet, and to facilitate drying of the ball held therein when the ball is wet.

### SUMMARY OF THE INVENTION

In one embodiment, the present invention is directed to a ball holder which includes a first and a second hollow hemispherical shell of an equal diameter, each hemispherical shell having therein a plurality of apertures; the first hemispherical shell including a first hinge part disposed at a circumference thereof and, diametrically opposed therefrom, a first closure element; and the second hemispherical shell including a second hinge part at a circumference thereof attached to the first hinge part thereby enabling turning the first or the second hemispherical shell relative to each other to open or close the ball holder, and a second closure element disposed diametrically opposed from the second hinge part and in alignment with the first closure element when the ball holder is closed; and a plurality of protuberances spaced apart along an internal surface of at least one of the hemispherical shells, the protuberances configured to form discrete contact points with a ball to be held in the ball holder and to separate the ball from the internal surface thereby reducing surface contact areas of the ball with the internal surface to facilitate drying the ball.

In a further embodiment, the present invention is directed to a ball holder assembly including the ball holder described above and a releasable locking attached to the first and second closure elements through commonly aligned through-holes therein. The ball holder assembly may further include a ball, such as tennis ball, baseball, softball, golf ball, pin pong ball, rubber ball or other balls. The ball holder assembly may be carried by a person or a pet through the releasable lock.

It is therefore an object of the present invention to provide a ball holder or a spherical article holder of the above type capable of drying a ball or an article held therein.

It is another object to provide a ball or article holder of the above type in which the evaporation of moisture from a wet ball or article held therein will occur in a manner which is efficient but not inconvenient or uncomfortable to a user.

It is a further object of the present invention to provide a ball holder of the above type which is pleasing in appearance to the user or an animal, such as a pet, with which the ball holder may be used.

It is still another object to provide an assembly of the above type that may be readily attached to a dog collar, a belt, belt loop, key chain, backpack, hand bag or other such article.

It is yet another object to provide a ball holder of the above type that may hold pet treats or bells by which a pet can be tracked if necessary when the ball holder is attached to a collar of the pet. It is a still further object to provide a ball holder of the above type which may, itself, be used as a dog or pet toy both on the ground and in a lake.

The advantages of the present invention will become apparent from the following description taken in conjunction with the accompanying drawings showing exemplary embodiments of the invention.

### BRIEF DESCRIPTION OF THE DRAWINGS

FIG. 1 is a top view showing the respective hollow semi-hemispheres of a spherical article holding system in some embodiments.

FIG. 2 is an assembly view showing the respective semi-hemispheres connected along their respective hinge elements.

FIG. 3 is an internal fully open view of the system in which are shown internal offset elements separating the held ball from the interior surface of the structure.

FIG. 4 is a perspective assembled view of the spherical article holding system showing the use of an elongate ring to secure the closure elements of the spherical article holding system together.

FIG. 5 is a rear view of FIG. 4, taken through a cross-section of the hinge parts of the system through a common axis thereof.

FIG. 6 is a front view of the spherical article holding system of FIG. 4, including a cross section taken through the closure elements of the respective semi-hemispheres.

FIG. 7 is a view showing the use of a steel bolt and locknut as an axis of the hinge structure in some embodiments.

FIG. 8 is a view, similar to FIG. 3, said view including an obverse view of the hinge structure of FIG. 7.

FIG. 9 is a perspective view similar to FIG. 4 but showing the use of a S-binder type lock.

FIG. 10 is a perspective view of a ball holder in a further embodiment.

FIGS. 11A, 11B and 11D are a perspective view, a top view of the external side, and a top view of the internal side of the first hemispherical shell, respectively, in the ball holder shown in FIG. 10. FIG. 11C is a cross-sectional view of the first hemispherical shell along line 11C-11C in FIG. 11B.

FIGS. 12A, 12B and 12D are a perspective view, a top view of the external side, and a top view of the internal side of the second hemispherical shell, respectively, in the ball holder shown in FIG. 10. FIG. 12C is a cross-sectional view of the second hemispherical shell along line 12C-12C in FIG. 12B.

FIGS. 13A and 13B are a rear and a front perspective view, respectively, of the ball holder shown in FIG. 10 in a closed position.

FIG. 14 is a perspective view of a ball holder in another embodiment of the present invention.

FIGS. 15 and 16 are a side view and a top view, respectively, of the ball holder shown in FIG. 14 in a closed position.

FIG. 17 is a perspective view of the ball holder shown in FIG. 14 in a fully opened position.

FIGS. 18 and 19 are a top view and a bottom view, respectively, of the ball holder shown in FIG. 14 in a fully opened position.

FIG. 20 is a perspective view of the ball holder shown in FIG. 14 with a tennis ball placed therein.

FIG. 21 is an illustrated view of a ball holder of the present invention attached to a dog collar.

FIG. 22 is an illustrated view of a ball holder of the present invention attached to a backpack.

FIG. 23 is a perspective view of a ball holder in a further embodiment of the present invention.

FIG. 24 is a perspective view of a hollow hemispherical shell in the ball holder shown in FIG. 23.

### DETAILED DESCRIPTION OF THE INVENTION

Embodiments of the present invention generally relate to a spherical holder for carrying a ball or other suitable articles by a person or a pet and for effectively drying a ball held therein if the ball becomes wet after use. Embodiments of the invention are described more fully hereinafter with reference to the accompanying drawings. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art. Elements that are identified using the same or similar reference characters refer to the same or similar elements.

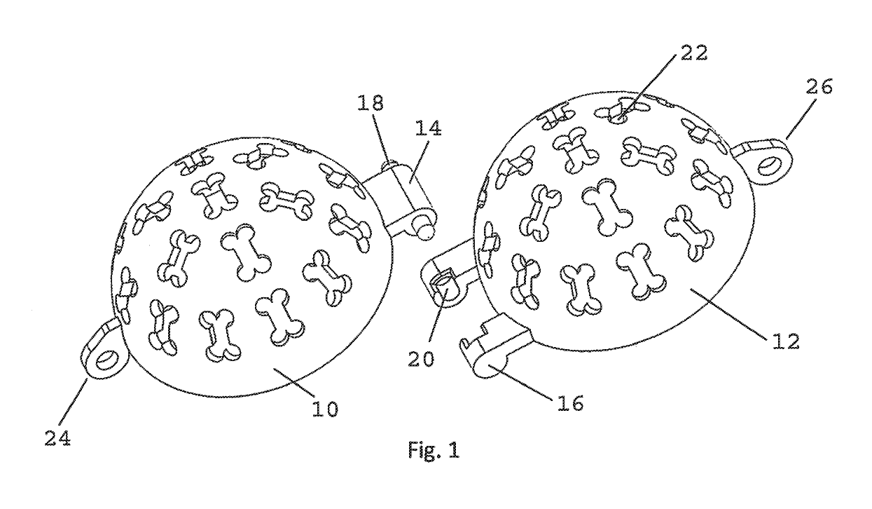

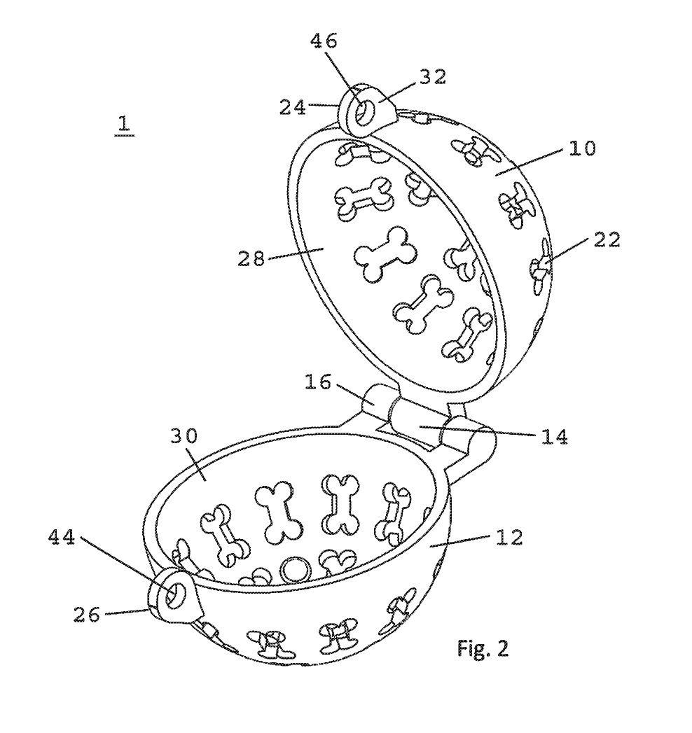

In some embodiments, a spherical article holding system 1 includes a first hollow resilient semi-hemisphere 10 and a second hollow resilient semi-hemisphere 12, each of equal diameter, see FIG. 2. As may be further noted in FIG. 1, each semi-hemisphere is provided with a respective hinge part, namely, a first hinge part 14 with a screw, pin or axle 18 in the case of the first element 10, and a second hinge part 16 with channels 20 in the case of the second element 12. The first hinge part 14 is complementally engagable by channels 20 of the second hinge part 16, such that the screw, pin or axle 18 of first hinge part 14 may be readily positioned into channels 20 of the second hinge part 16.

FIG. 1 also shows the inclusion of a multiplicity of apertures 22 which, in an application involving the use of a tennis ball, golf ball, rubber ball or the like with a pet such as a dog, may each take the form of dog bone or the like. In some embodiments, the apertures, in aggregate, may occupy about 20% of surface area of the two semi-hemispheres, providing necessary breathability to the system. Alternatively, or in addition, a golf ball, bells, dog treats or a GPS may also be placed in the holder formed by the semi-hemispheres 10/12. The entire system may itself be used as a pet toy, including use in a body of water if the article contained therein has positive buoyancy.

Said semi-hemispheres, after attachment by their respective hinge parts 14/16 are shown in FIG. 2. Therein may also be seen complemental closure elements 24 and 26 which, upon the respective circumferences 28 and 30 of the respective semi-hemispheres 10/12, are longitudinally located close enough to each other such that the lateral sides 32 thereof produce a pressure or snap fit contact with each other. Also shown are apertures 44 and 46 within respective closure elements 24 and 26.

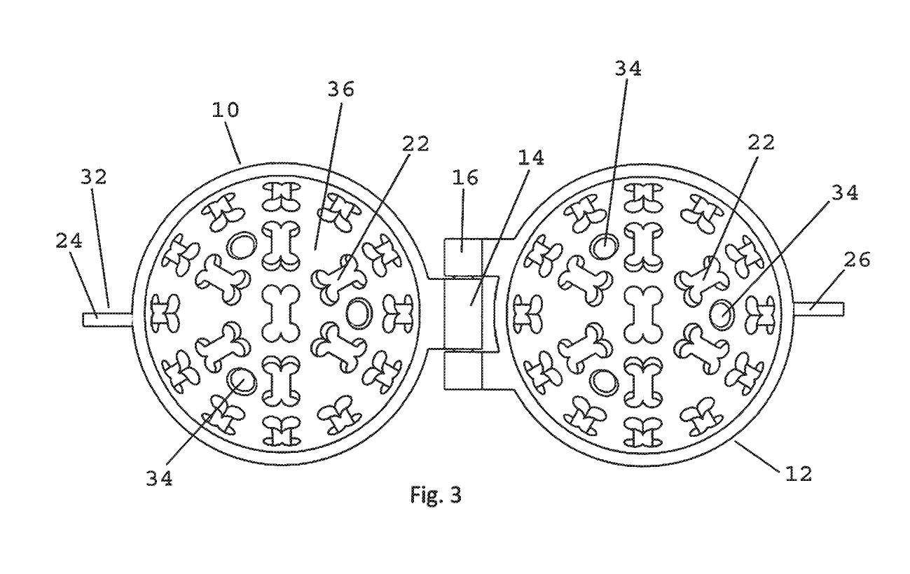

The structure of FIG. 2, when fully opened, may be seen from its interior in FIG. 3. Shown therein are offset elements 34 in the nature of knobs or stubs, the function of which is to assure that a spherical object placed therein will remain offset from internal walls 36 of the respective semi-hemispheres, thereby preventing most of the moisture or dampness associated with the balls, including golf balls, from uncontrollably dripping from the article. The offset elements are proportioned for the engagement of a ball or other article placed within the system. More specifically, the height, or the length toward the center of the ball holder, of at least a portion of the offset elements is sufficient to contact a sphere or other article held within the system.

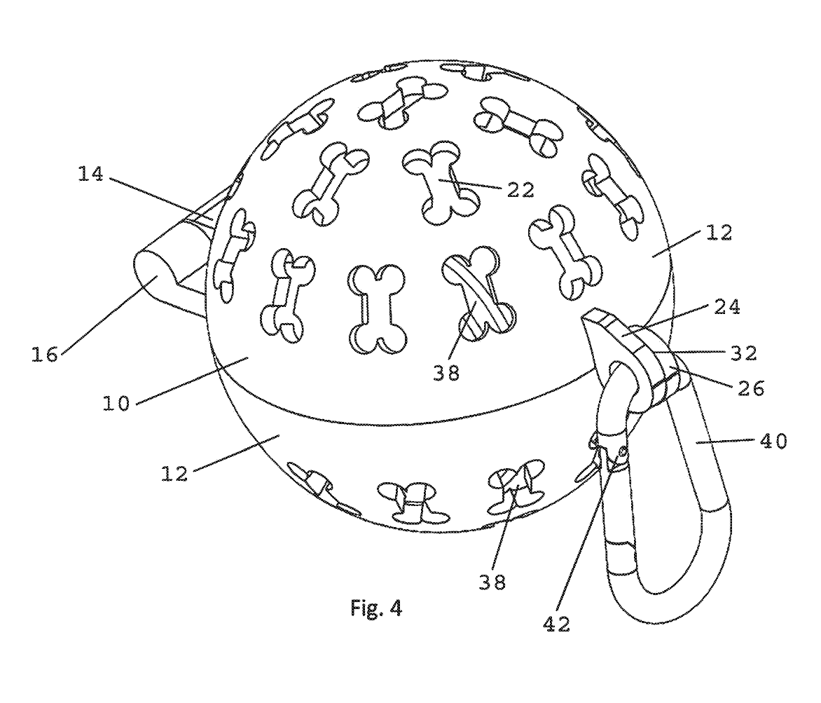

The system, when completely closed and engaging a ball 38, is shown in FIG. 4.

Therein may also be seen the manner in which closure elements 24 and 26 may be more reliably engage the system through the use of an elongate ring 40 which may be selectably opened and closed, as may be desired, by the use of a lever lock 42. The ring-like element comprises a release lock by which the system may be attached to a dog collar, belt, wall hook, backpack, or hand bag of a user of the system.

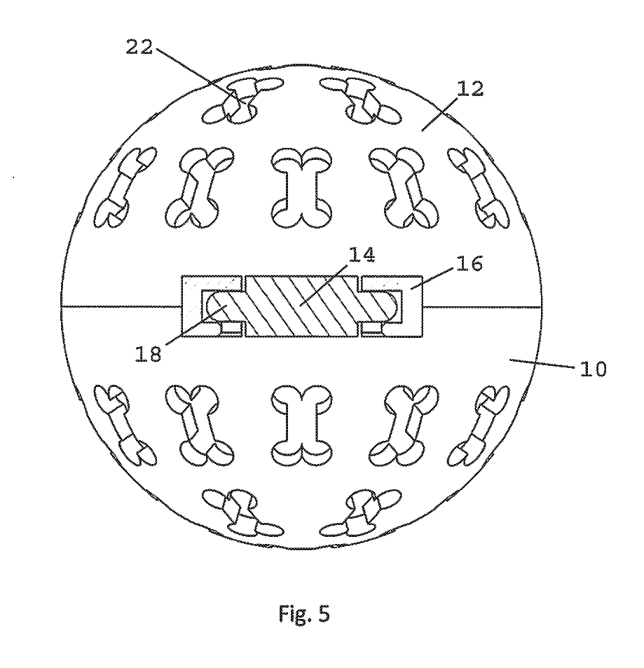

In FIG. 5 is shown a rear plan view of the inventive system in which the hinge parts 14 and 16 are shown in complemental relationship and through the axle 18 in contact with each other. It is noted that various types of screws and pins may be used as axle 18.

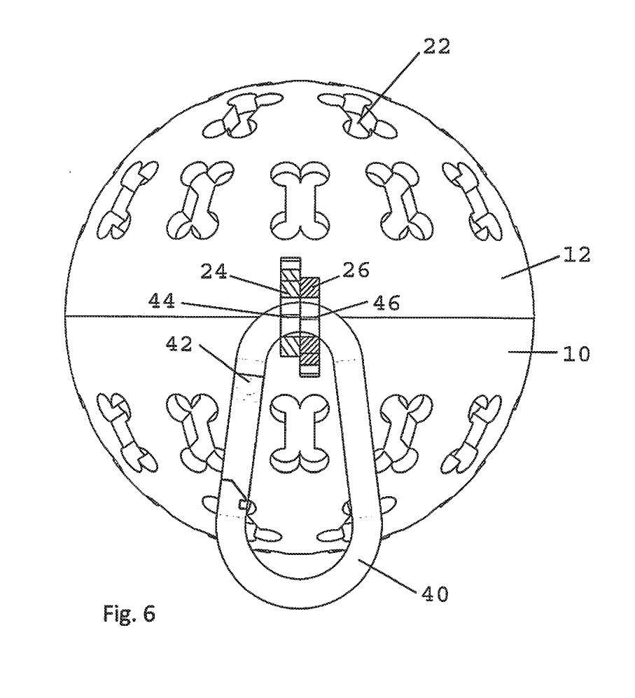

FIG. 6 is a front view of the system of FIG. 4, showing in cross-section pressure fit closure elements 24 and 26 and the manner in which ring 40 may be used to secure closure elements 24 and 26 together when the ring is passed through a commonly aligned apertures 44 and 46 which thereby form a single aperture. See also FIG. 2. Therefore, closure between the responsive closure means is assured by the use of a ring-like element slip-fittably passing between complementally disposed apertures within the closure elements.

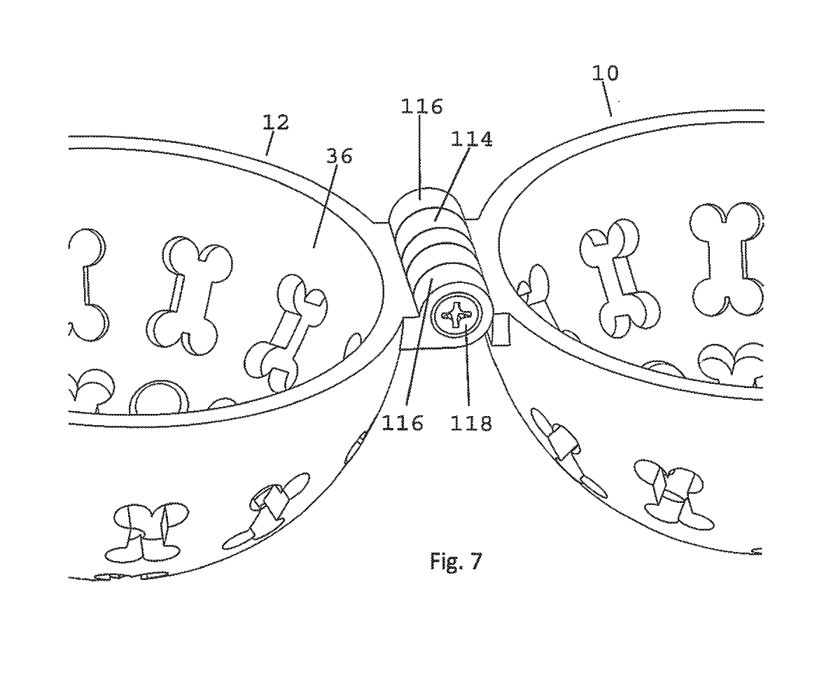

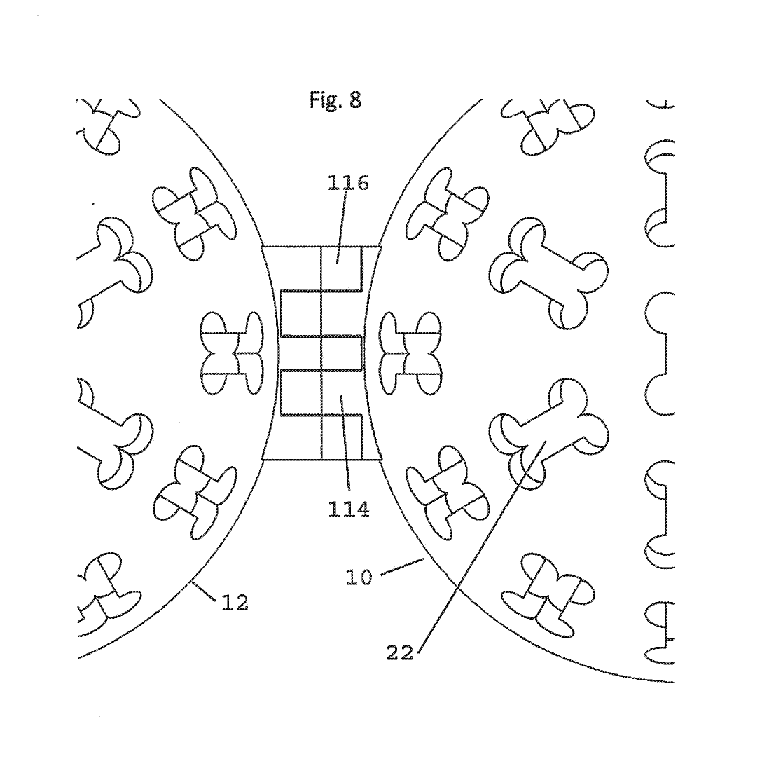

In FIG. 7 is shown the use of either a screw or locknut bolt 118 between hinge parts 114 and 116 in an alternative embodiment. FIG. 8 is an obverse view of the hinge of FIG. 7. As shown, hinge part 114 has two prong extensions and hinge part 116 has three prong extensions, and a locknut bolt or screw 118 joins hinge parts 114 and 116 together through coaxially aligned through-holes in the extensions to form a hinge.

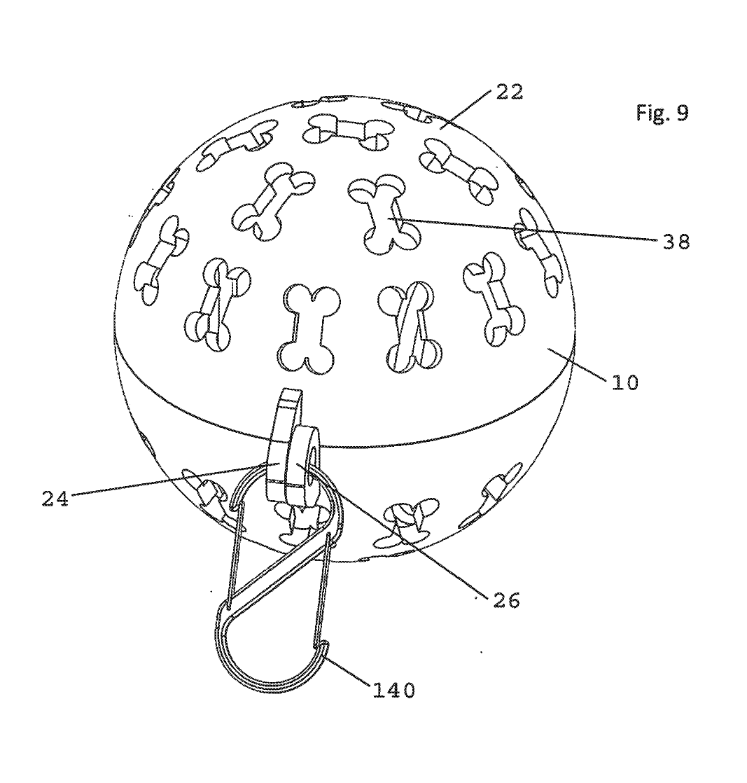

In FIG. 9 is shown the use of an S-binder or small carabineer lock 140 in lieu of the lock 40/42 shown in FIG. 6.

In some embodiments, the spherical article holding system may be used as a utility belt attachment by which a tennis ball, golf ball or the like may be held for the purpose of drying the same if they become wet, for transport of such tennis or golf balls, securely holding and covering such a spherical article, before or during practice or the play of a match. It is further noted that the entire system, above discussed, may be employed as a dog toy that bounces about irregularly as a function of the size, density and geometry of the article therein, and may float if said article possess a positive buoyancy. Bells or a GPS may also be provided within the system or shells so that a dog wearing the system may be tracked if he were to run off.

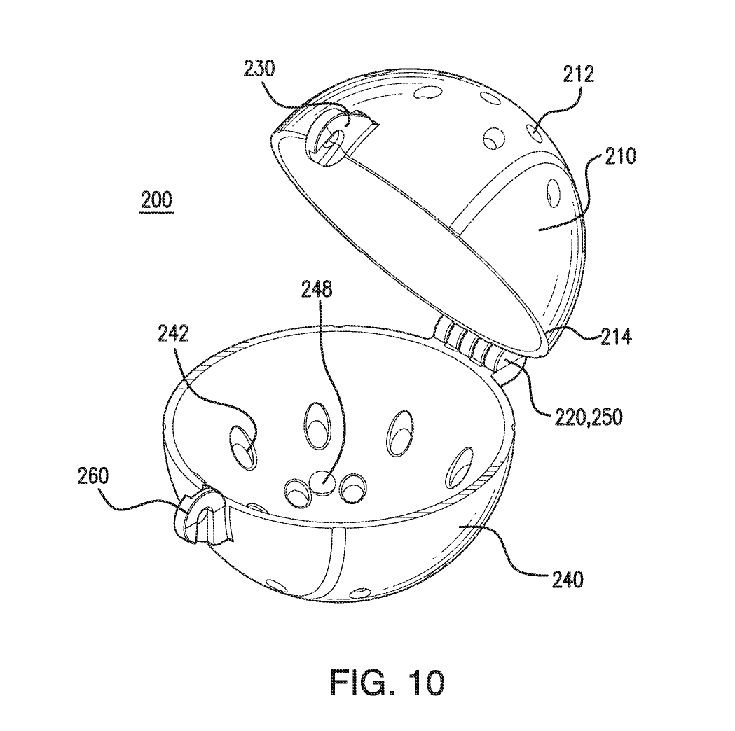

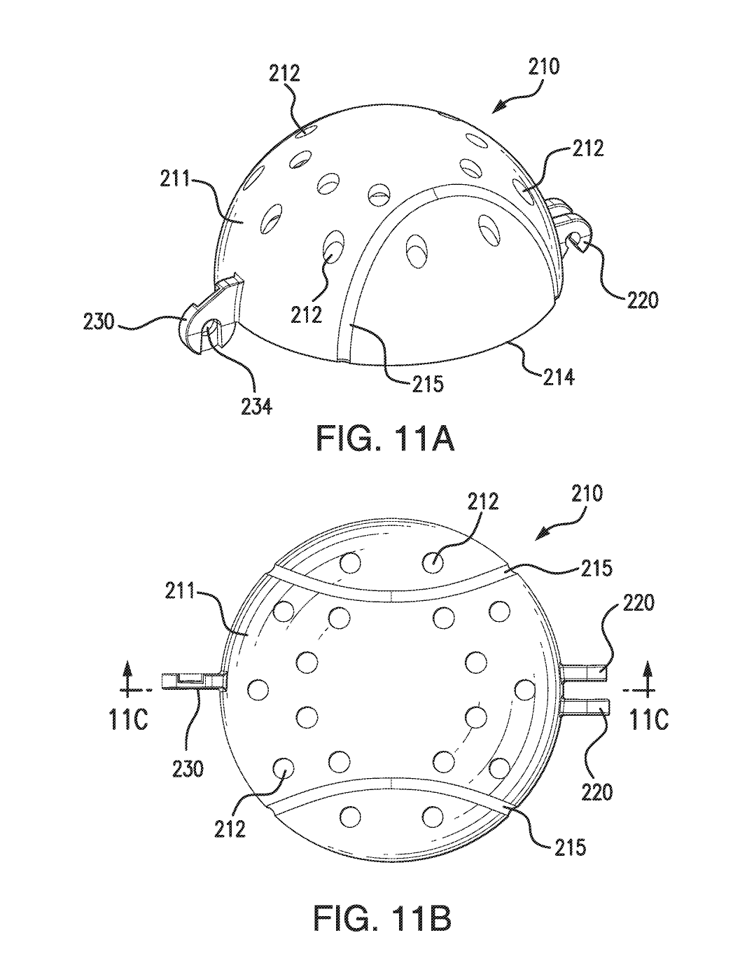

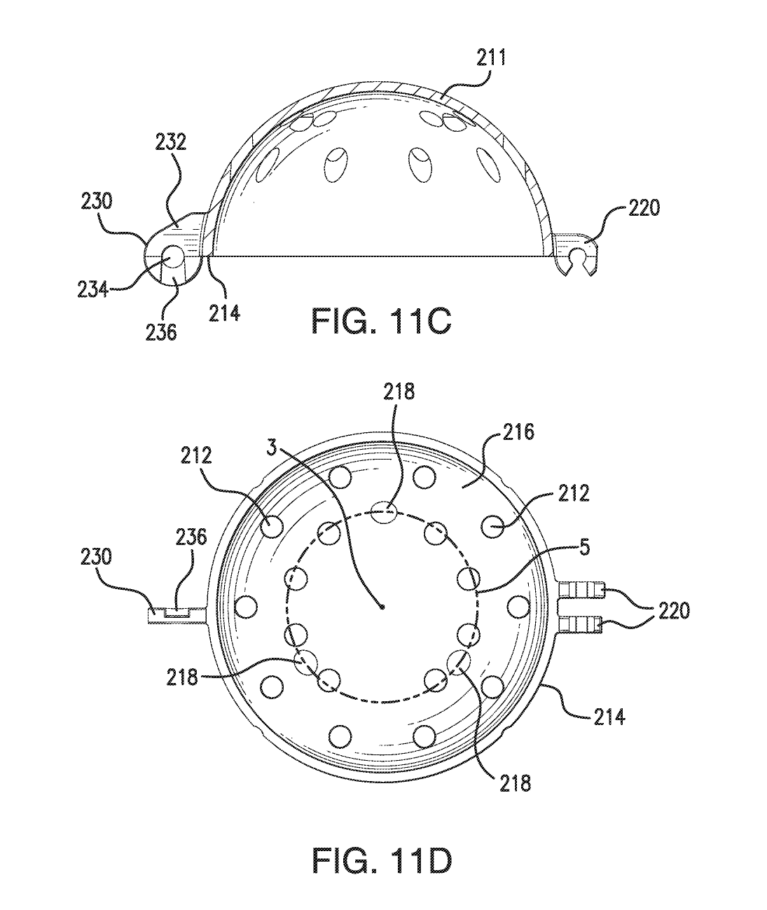

FIGS. 10 thru 13B illustrate a ball holder in further embodiments of the present invention. As shown in FIG. 10, a ball holder 200 includes a first hollow hemispherical shell 210 and a second hollow hemispherical shell 240 of an equal diameter connected with each other through their respective hinge parts. FIGS. 11A-11D show the structure of first hemispherical shell 210 and FIGS. 12A-12D show the structure of second hemispherical shell 240, respectively.

As shown in FIGS. 11A-11D, first hemispherical shell 210 includes therein a plurality of apertures 212 distributed throughout the shell, a first hinge part 220 disposed at circumference 214 of first hemispherical shell 210, and a first closure element 230 disposed diametrically opposed from first hinge part 220. Similarly, as shown in FIGS. 12A-12D, second hemispherical shell 240 includes therein a plurality of apertures 242 distributed throughout the shell, a second hinge part 250 disposed at circumference 244 of second hemispherical shell 240 and a second closure element 260 disposed diametrically opposed from second hinge part 250.

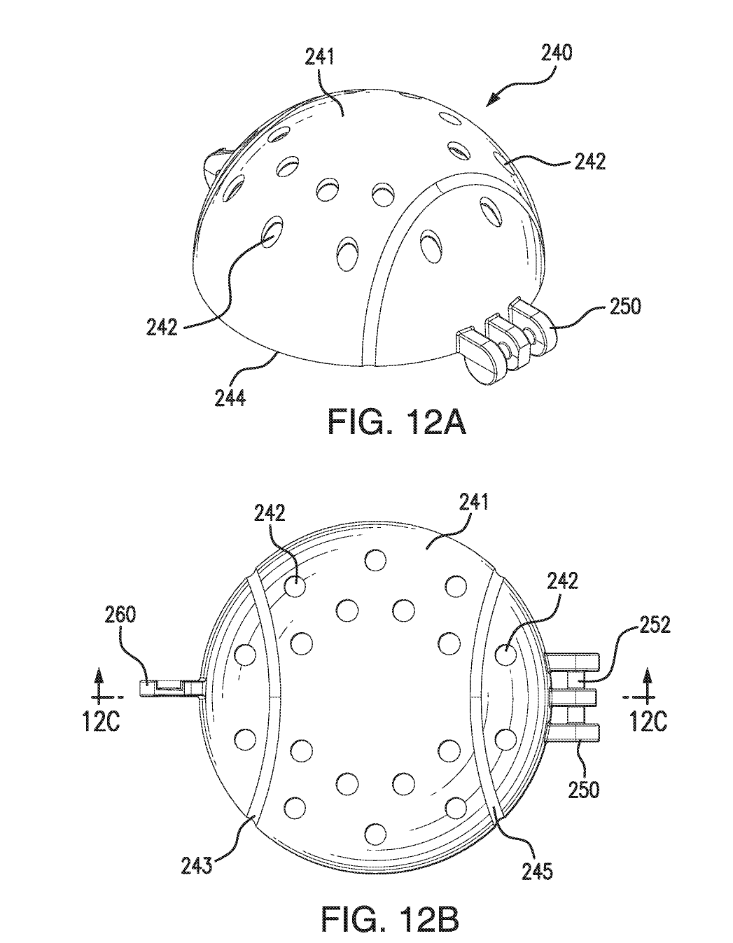

As more clearly shown in FIGS. 12A and 12D, second hinge part 250 on second hemispherical shell 240 includes an axle 252 supported by ribs 254. On the other hand, as shown in FIGS. 11C and 11D first hinge part 220 on first hemispherical shell 210 is in a form of two C-channel elements complimentary with and configured to snap-fit with axle 252 of second hinge part 250. As shown in FIG. 13A, once they snap-fit together the pivotally connected first and second hinge parts 220, 250 form a hinge of ball holder 200, which enables turning the first and the second hemispherical shell relative to each other around axle 252 to open or close the ball holder, see FIG. 10 also. Alternatively, the first hinge part may have one extended C-channel element which complimentarily engages with the axle on the second hinge part which may have the supporting ribs only at two ends of the axle. Other suitable configurations of the first and second hinge parts may also be used.

As further shown in FIGS. 11A and 11C, first closure element 230 is in a form of a tab extending radially from external surface 211 at circumference 214 of first hemispherical shell 210. Similarly, second closure element 260 is in a form of a tab extending radially from external surface 241 at circumference 244 of second hemispherical shell 240, see FIGS. 12A and 12C. The first closure element 230 includes a through-hole 234 on its lateral side 232, and second closure element 260 includes a through-hole 264 on its lateral side 262. As further shown in FIGS. 11B and 12B, the first and second closure elements 230, 260 are disposed immediately off centerline 11C-11C, 12C-12C of each hemispherical shell and on opposing side of the centerline. When the ball holder is closed as shown in FIG. 13B, first closure element 230 and second closure element 260 are aligned with their lateral sides facing each other. At this closed position, through-holes 234, 264 are aligned with each other thereby forming a common through-hole for engagement with a releasable lock. When a releasable lock is used to secure the ball holder, no pressure fitting engagement is required between the two closure elements. In the embodiment shown, the first and second closure elements 230, 260 are substantially perpendicular to their circumference. Alternatively, the first and second closure elements may be in parallel with their circumference, while the axis of the through-holes is perpendicular to respective circumference 214, 244.

As further shown in FIGS. 11A and 11C, optionally first closure element 230 may further include a groove 236 extending from through-hole 234 to the low end of first closure element 230. Similarly, second closure element 260 may include a groove 266 extending from through-hole 264 to the upper end of second closure element 260. As can be seen in FIG. 13B, groove 236, 266 reduces the thickness of the tab within the groove, which easies attachment of a releasable lock through the common through-hole, particularly when a releasable lock having a ring-like element of a very small radius is used.

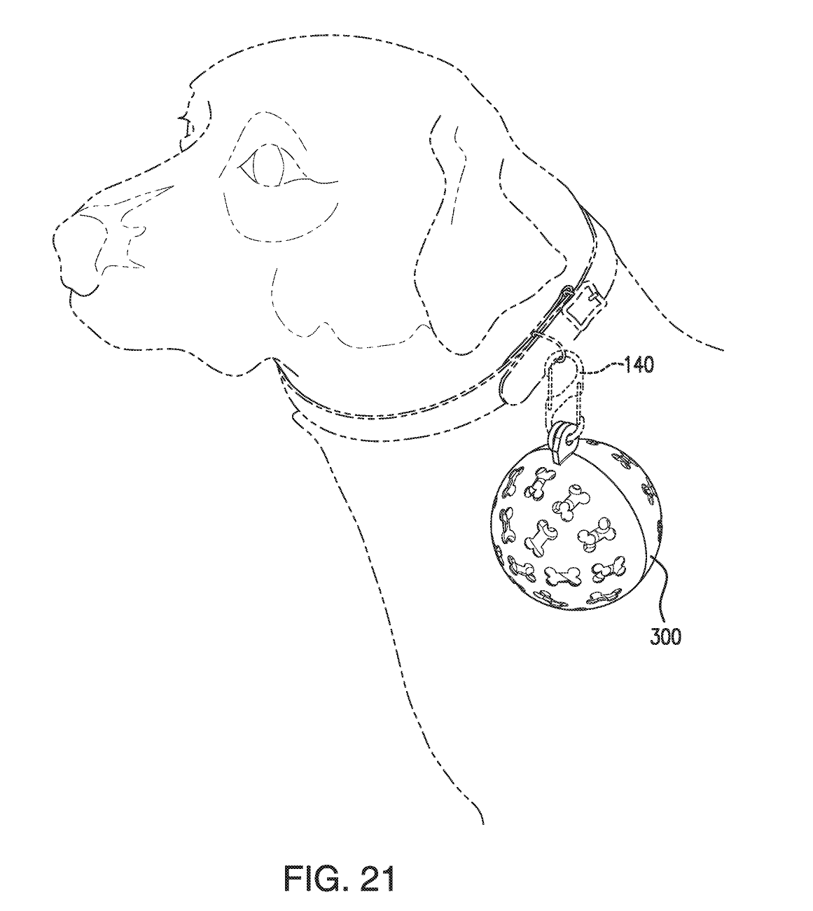

The apertures 212 and 242 in first and second hemispherical shell 210, 240 are sized for venting the interior of the ball holder. In some embodiments, each aperture may be from about 15 to about 80 square millimeter (mm²). The number and size of apertures may vary depending on specific designs. In general, to vent the interior of the ball holder, the accumulated open area of the apertures in each hemispherical shell may be from about 5% to about 75% of the total surface area of the external surface of each hemispherical shell. In ball holder 200, apertures 212 and 242 are in circular, and oval shape at certain viewing angles. The apertures may assume various decorative shapes, such as geometric shapes, a dog bone shape as shown in FIG. 2, a star shape as shown in FIG. 22, a crescent moon shape and others. In addition, in the embodiment shown first hemispherical shell 210 includes two surface grooves 215 and second hemispherical shell 240 includes two surface grooves 245, which jointly form a continuous groove when the ball holder is closed, resembling the surface groove on a tennis ball. As such, a closed ball holder 200 itself looks like a tennis ball and provides attractive appeal to users such as sport fans.

As a distinct structural feature, at least one of hemispherical shells 210, 240 includes a plurality of protuberances, also referred to as offset elements, on the internal surface or wall, spaced apart along the internal surface of the hemispherical shell. In ball holder 200, both first and second hemispherical shells include a plurality of protuberances. As shown in FIGS. 11D and 12D, first hemispherical shell 210 has a plurality of protuberances 218 spaced apart along internal surface 216, and second hemispherical shell 240 has a plurality of protuberances 248 spaced apart along internal surface 246, respectively. The protuberances 218, 248 may be in the form of bumps, bulges, knobs or the like, and generally have a smooth top surface. In some embodiments, the protuberances may have a height from about 1 to about 5 millimeters (mm) and a width from about 2 to about 5 mm. These protuberances form discrete contact points with a ball held in the ball holder, which separate or offset the surface of the ball from internal surfaces 216, 246 of the hemispherical shells, and hence substantially reduce surface contact areas of the ball with the internal surfaces 216, 246.

As can be understood, for holding a specific spherical object, such as a tennis ball, baseball, softball, golf ball, ping pong ball, or other balls, the inner diameter of the hemispherical shell is complementary to a sum of a diameter of the subject ball and the height of the protuberances in both shells. In an exemplary embodiment, the ball holder for holding a tennis ball of 2.5 inches in diameter may have an inner diameter about 2.75 inches, and the protuberances in each hemispherical shell may have a height about 0.125 inch (equal to 3.175 mm). In general, a ratio of the height of the protuberances to the inner diameter of a hemispherical shell is less than 8% such that the size of the ball holder is comparable to and not substantially larger than the ball to be held therein.

As can be appreciated, a spherical object, such as a tennis ball, placed within ball holder 200, will be supported by protuberances 218, 248, which separate or offset the tennis ball from the internal surfaces 216, 246 of the hemispherical shells. In other words, the tennis ball is held largely in a suspended manner inside the ball holder and most surface of the ball is not pressed against the internal surface of the ball holder. As such, if the tennis ball is moist, such as in the situation that the ball is used when the tennis court is wet, or after a tennis ball is played by a dog, the tennis ball dries faster in ball holder 200, because the surface of the tennis ball is more exposed to air due to substantially reduced surface contact between the tennis ball and the internal surface of the shells. Moreover, in a situation where a tennis ball is soaking wet, the suspended holding manner in the instant ball holder also reduces likelihood of dripping of water from the ball holder caused by pressing of the wet surface of the tennis ball against the internal surface of the ball holder. As can be further understood, a gap created by lifting or offsetting a ball from the internal surface of the ball holder also improves air circulation within the ball holder, which further facilitate drying of a wet ball held therein.

The height of the protuberances may also depend on the type of ball to be held within the ball holder. For example, for carrying a ball without a compressible or deformable exterior, such as a ping pong ball, a minimum height of the protuberances, such as 1 mm, may be sufficient to suspend a ping pong ball. On the other hand, for carrying a tennis ball which has a furry surface, the height of the protuberances may be higher, such as about 3 mm, such that the protuberances prevent the hairs on the exterior of the tennis ball from contacting with the internal surface of the hemispherical shells.

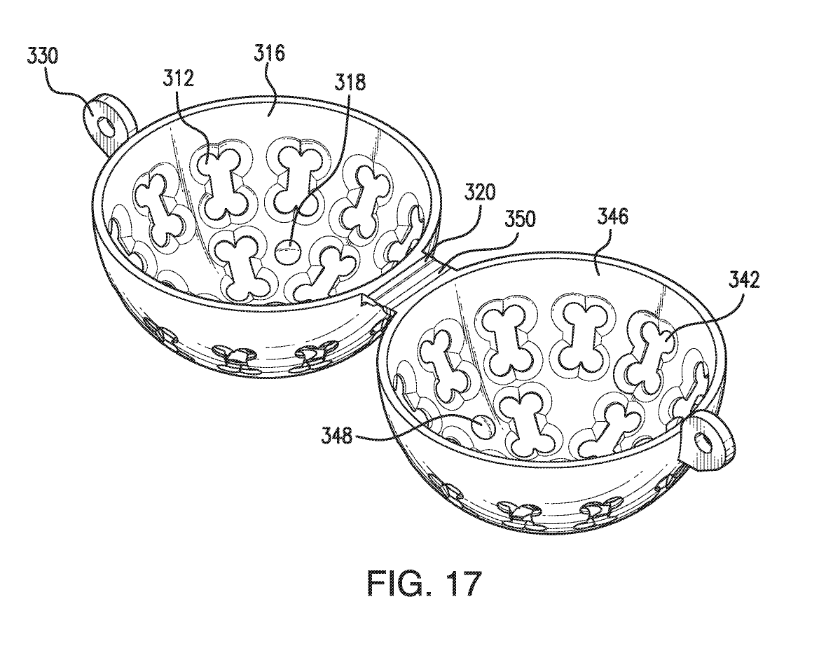

As further shown in FIG. 11D, three protuberances 218 are disposed circularly along an imaginary circle 5 that is formed by an imaginary plane intercepting hemispherical shell 210, with substantially equal distance between one and another. In general, the distance between one protuberance and the next, which is herein referred to as an interval distance, may be the same or comparable to one and another among the three protuberances to provide a balanced support to a ball held within the ball holder. Similarly, as shown in FIG. 12D, three protuberances 248 are distributed circularly in the same manner in hemispherical shell 240. The same distribution pattern may also be seen with other embodiments described herein, see FIGS. 3 and 18. As can be appreciated, to completely lift a spherical object in one side of the ball holder, at least three protuberances disposed circularly are needed. This distribution pattern enables support of a spherical object by the protuberances in a balanced manner, and the surface contact areas between a ball and the internal surface of the ball holder can be minimized, for example the extent of reduction in surface contact areas can be more than 90%. In further embodiments, more than three protuberances may also be used.

In the exemplary embodiment shown in FIGS. 11D and 12D, the circle along which protuberances 218, 248 are distributed (i.e., imaginary circle 5 illustrated in FIG. 11D) is parallel with the circumference of respective hemispherical shell, and the protuberances 218, 248 are distanced from axial center 3 of respective hemispherical shell. In general, a radial distance, namely, from axial center 3 to circumference 214 of hemispherical shell 210, may be from about 20% to about 70% of the radius of respective hemispherical shell, see FIG. 11D.

In further embodiments, the protuberances may also be disposed circularly along more than one imaginary circle, which may be positioned at different portions of the internal surface of the ball holder. It should be understood that the imaginary circle 5 is not limited to only within one hemispherical shell, and it can be formed by an imaginary plane intercepting the sphere formed by the ball holder. Therefore, an imaginary circle may include a portion of each hemispherical shell. Moreover, other distribution patterns of the protuberances may also be used.

In the ball holders described herein, both first and second hemispherical shells may be made of plastics, such as polyvinyl chloride (PVC), polyethylene and polypropylene, by plastic molding.

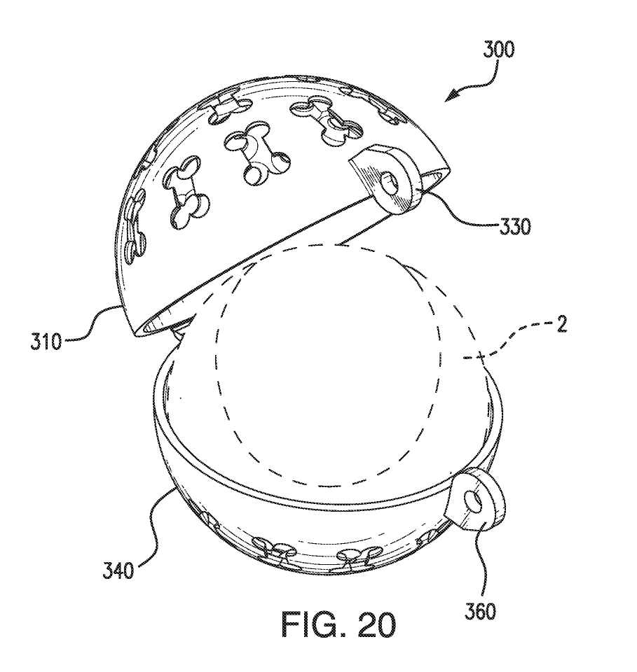

Same as shown in FIGS. 4 and 9, ball holder 200 may further include a releasable lock which attaches to the first and second closure elements 230, 260 through the common through-hole, and locks ball holder 200 in the closed position. The releasable lock can be removed from the ball holder to place a ball in the ball holder or retrieve the ball from the ball holder. Various commercially available ring-like locks, clips, or hooks can be used as a releasable lock with the instant ball holders. Suitable examples include S-binder locks, carabineer locks or clips, round or oval split ring, S-hook, C-hook, metal locking ring or clips, and other suitable locks. As further illustrated in FIGS. 21 and 22, the releasable lock can be used to attach the ball holder to a pet or a person, such as attach to a dog collar as shown in FIG. 21, or an item carried by a person or pet, such as attach to a hand bag or a backpack as shown in FIG. 22.

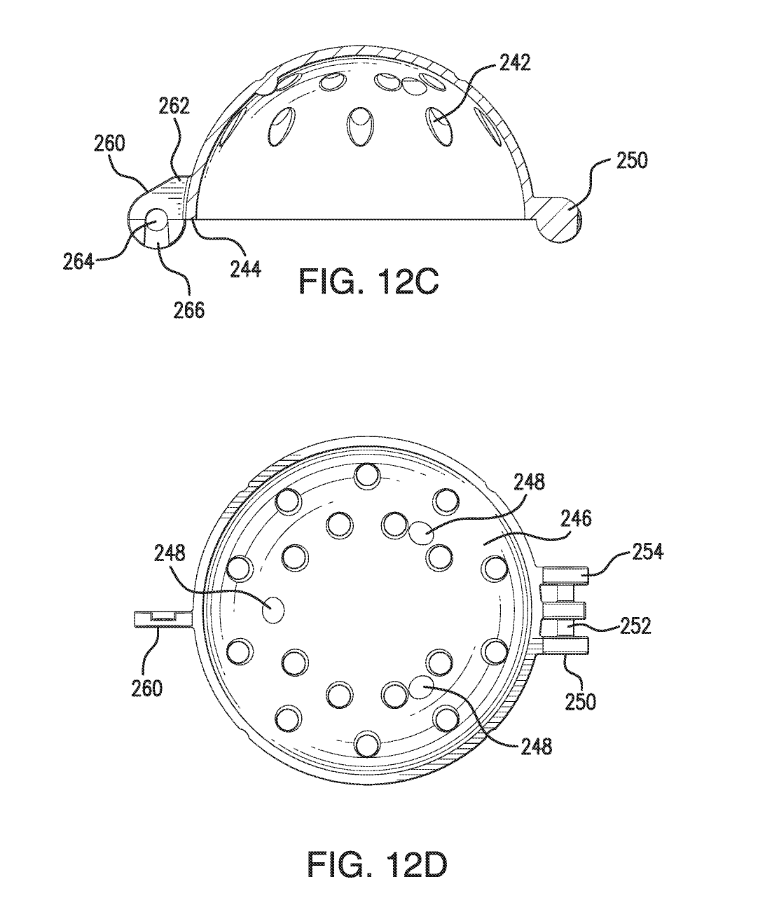

FIGS. 14-19 further show a ball holder 300 in further embodiments of the present invention. The structure of ball holder 300 is similar to that described above in ball holders 1 and 200, except that in ball holder 300 an integral living hinge connects the first and second hollow hemispherical shells 310, 340.

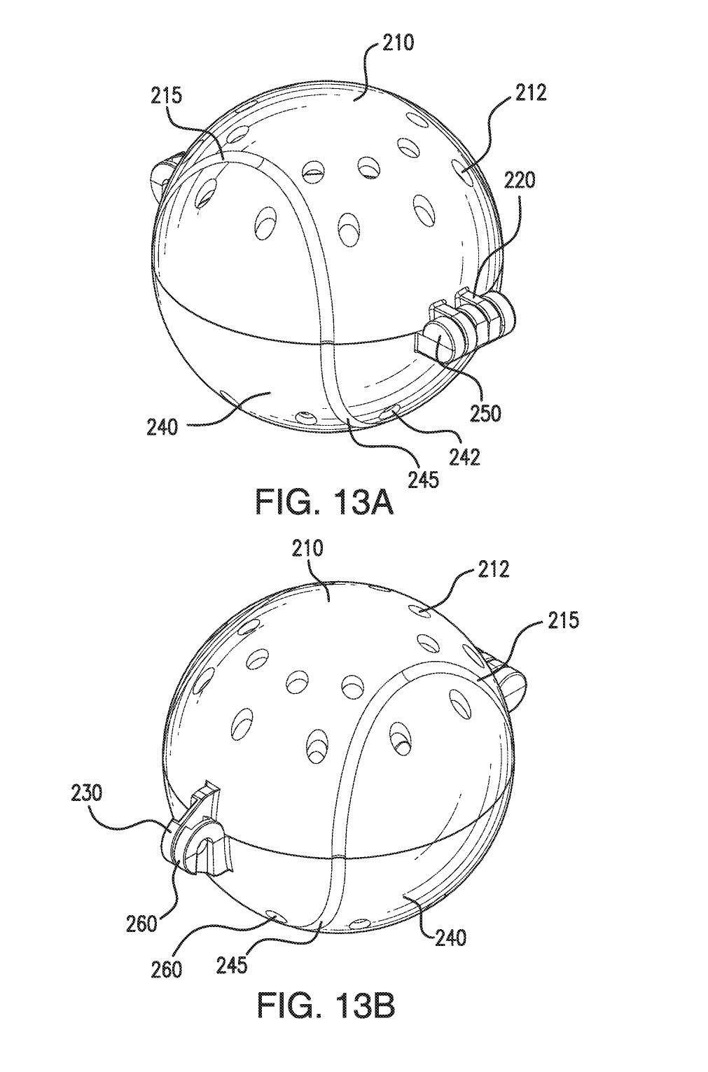

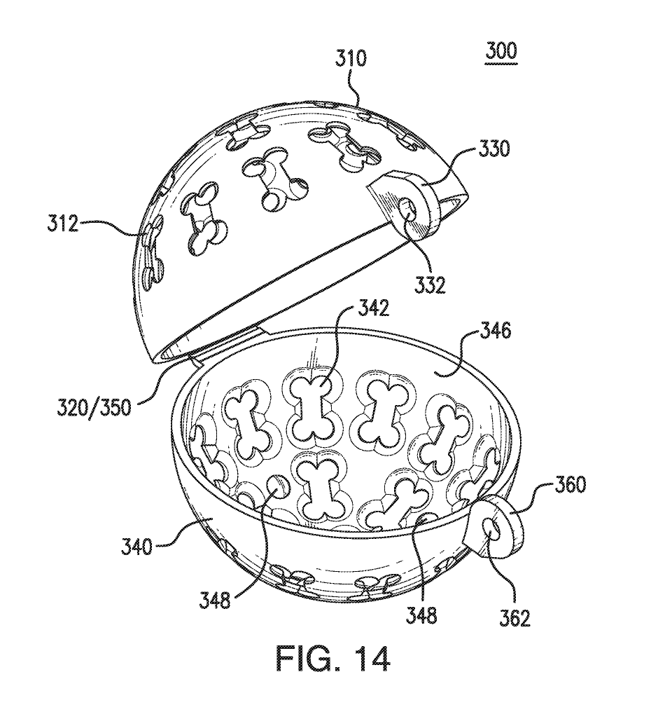

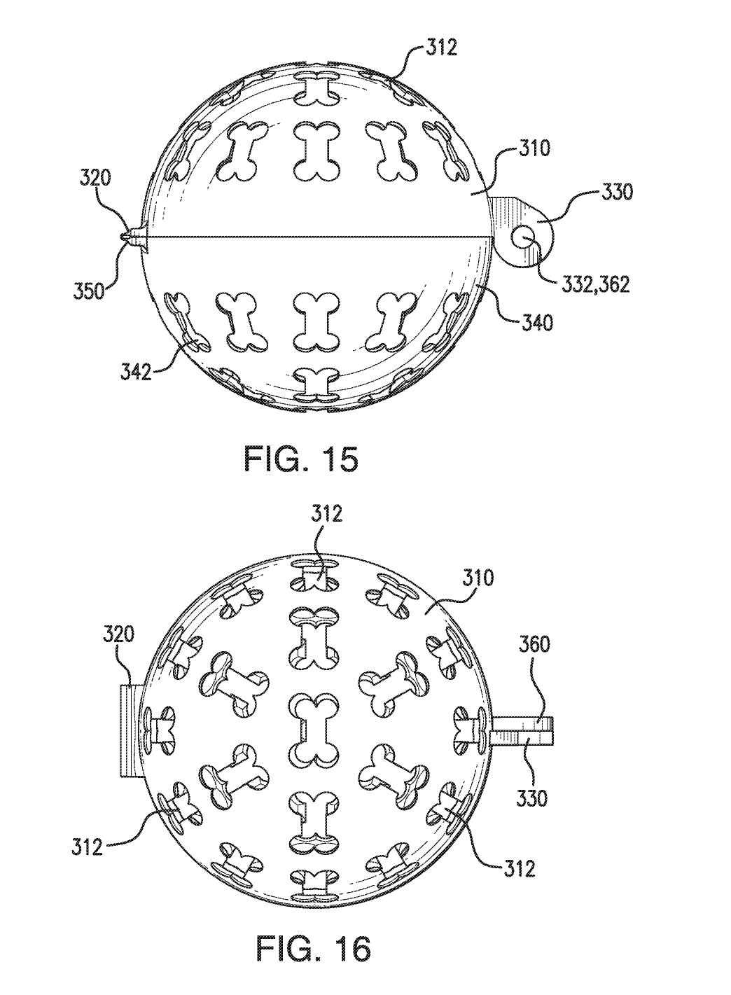

As shown in FIG. 14, each of first and second hemispherical shells 310, 340 includes a plurality of apertures 312, 342 therein with a dog bone shape. In its closed position shown in FIGS. 15 and 16, first and second closure elements 330, 360 are aligned with each other, and their commonly aligned through-holes 332, 362 form a common through-hole for engagement with a releasable lock as described above, see FIG. 14 also. As shown in FIGS. 15 and 17, in this embodiment first hinge part 320 and second hinge part 350 are integral parts of a living hinge. With this hinge structure, ball holder 300 can be produced by plastic molding as a single piece structure with the integral living hinge connecting between the two hemispherical shells.

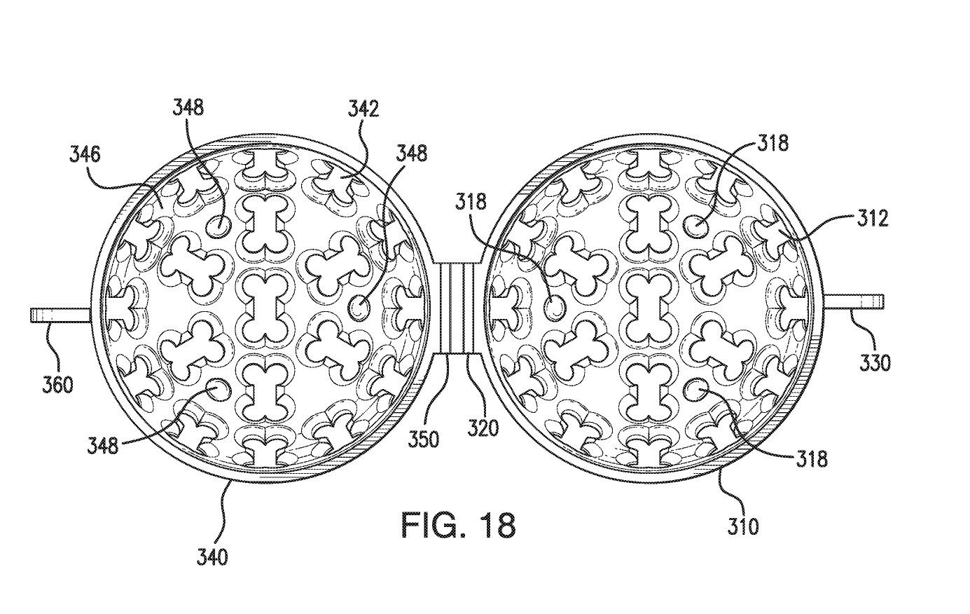

FIG. 18 shows a top view of ball holder 300 in its fully opened position, showing the interior of ball holder 300. As shown, each of first and second hemispherical shells 310, 340 includes a plurality of protuberances 318, 348 spaced apart along respective internal surface 316, 346, also see FIG. 17. FIG. 19 shows the external side of fully opened ball holder 300, which is an obverse view of FIG. 18, showing the external side of the living hinge in such a position.

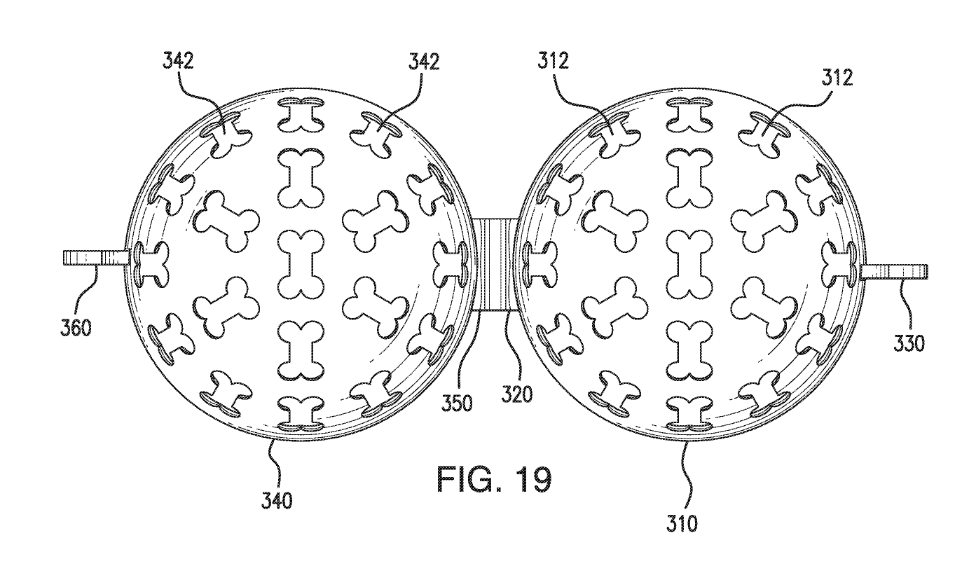

FIGS. 20-21 illustrate the use of ball holder 300 in some embodiments. The same utility applies to other embodiments described herein. As shown in FIG. 20, a tennis ball 2 is placed in and to be carried by ball holder 300. FIG. 21 illustrates a ball holder 300 locked by a S-binder lock 140 through the common through-hole as described above and attached to a dog collar. For using the tennis ball as a pet toy, one can release the ball holder from the S-binder lock to retrieve the tennis ball. After the use, the tennis ball can be placed back into the ball holder and attached to the dog collar again. At this time, the tennis ball is usually wet and it can be dried naturally in the ball holder due to venting through the apertures and suspended holding of the tennis ball inside the ball holder as described above. Therefore, the instant ball holder in which a tennis ball, baseball, golf ball, rubber ball of the type which dogs enjoy chewing upon or other article may be stored conveniently upon a dog collar, belt loop, key chain, backpack, hand bag or other such articles and then conveniently opened at the convenience of the user or dog owner when access to the article is desired.

FIG. 22 further illustrates the use of a ball holder 300′ which has the same structure of ball holder 300 except that in ball holder 300′ the apertures in both hemispherical shells have a star shape. As shown, ball holder 300′ is attached to a backpack with a S-binder lock 140 and can be used conveniently by a student to carry a tennis ball, baseball, softball, or other balls to school or sport activities.

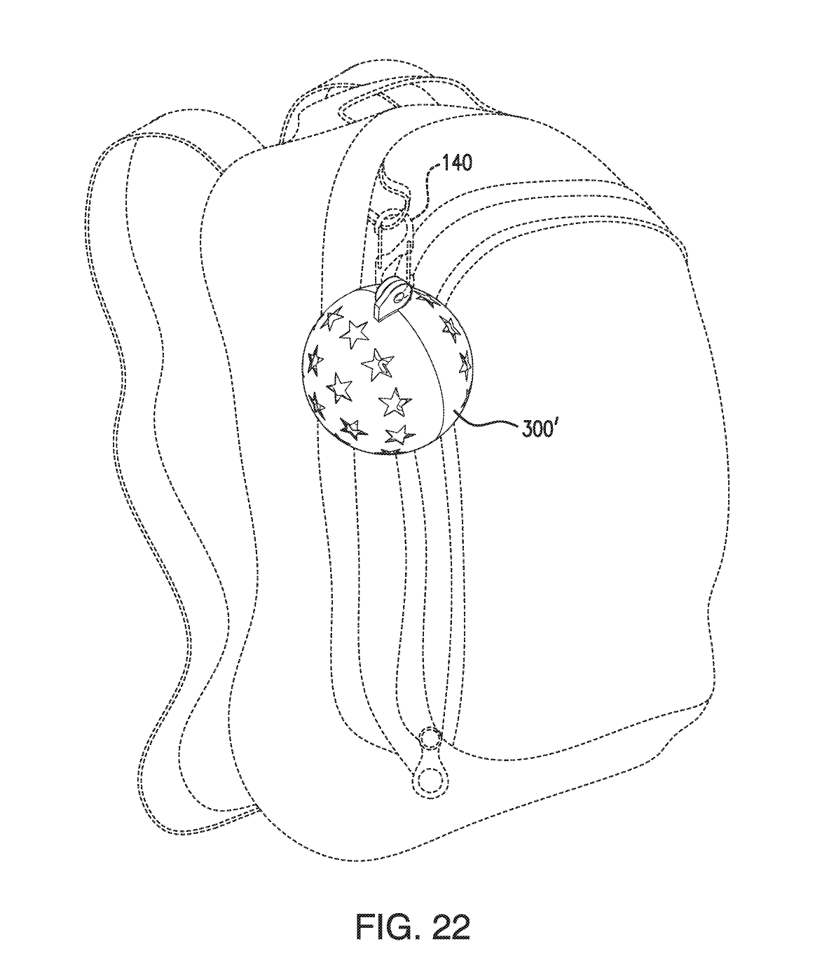

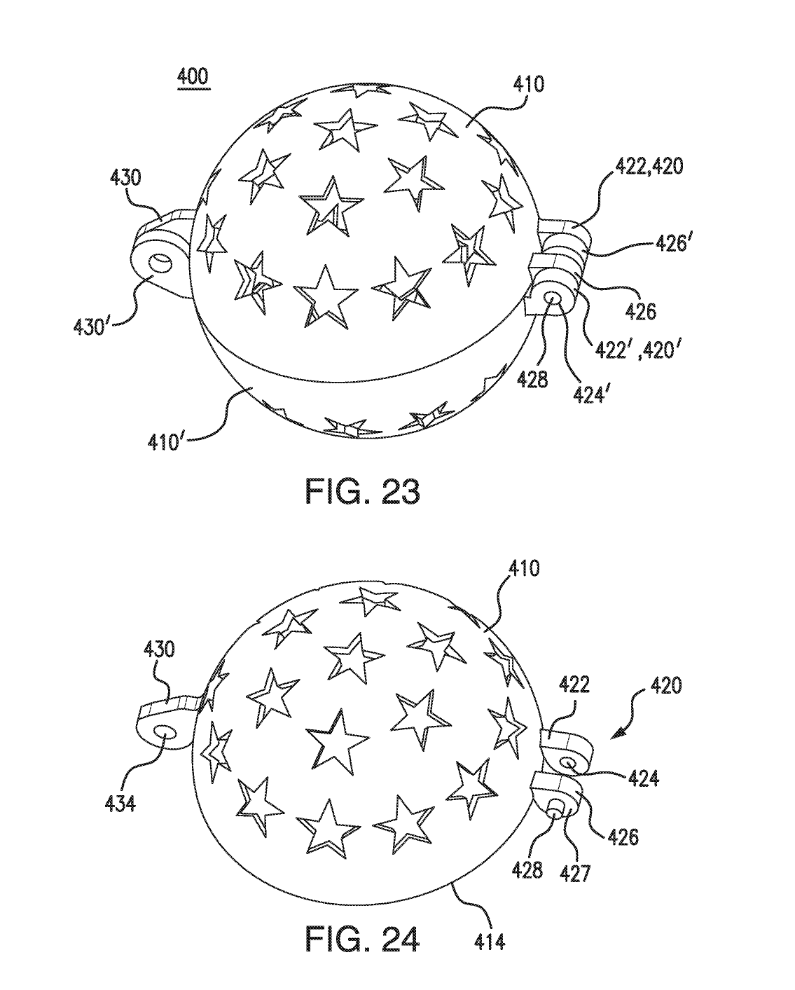

FIGS. 23-24 further show a ball holder 400 in another embodiment. As shown in FIG. 23, first and second hollow hemispherical shells 410, 410′ have substantially the same configuration of ball holder 300′ shown in FIG. 22, and the protuberances inside ball holder 400 are the same as that in ball holder 300 described above. However, the hinge parts and the closure elements in ball holder 400 have different structures.

In this embodiment, ball holder 400 is formed by assembling two identical hemispherical shell shown in FIG. 24 together, which is designated as first hemispherical shell 410 as well as second hemispherical shell 410′ in the assembled ball holder 400 shown in FIG. 23. For clarity, the structure of the hemispherical shell shown in FIG. 24 is described as the first hemispherical shell 410. As shown in FIG. 24, first hinge part 420 includes two protrusions extending from the external surface of the hemispherical shell at circumference 414 and with their lateral side perpendicular to the circumference. The first protrusion 422 has a central hole 424, and second protrusion 426 has an axial pin 428 on lateral side 427 of the protrusion axially aligned with central hole 424. On the opposing side of the hemispherical shell, first closure element 430 is in a form of a tab extending from the external surface of the hemispherical shell, and disposed off the centerline of the ball holder from the hinge parts to the closure element (see centerline 11C-11C in FIG. 11B), yet tilted slightly toward the centerline. The first closure element 430 has a through-hole 434.

When ball holder 400 is assembled, one hemispherical shell is flipped over which becomes the second hemispherical shell 410′ facing the first hemispherical shell 410 on the top, as shown in FIG. 23. The hinge part and the closure element in the flipped hemispherical shell 410′ is referred to as the second hinge part 420′ and the second closure element 430′, respectively, as indicated in FIG. 23. The hinge part of the hemispherical shell is so structured that the first and second hinge parts 420, 420′ snap-fit with each other. More specifically, axial pin 428 on the second protrusion 426 in first hinge part 420 snap-fit into central hole 424′ in the first protrusion 422′ of second hinge part 420′, and in the same manner, the axial pin on the second protrusion 426′ in second hinge part 420′ snap-fit into central hole 424 in the first protrusion 422 of first hinge part 420, thereby forming a hinge of the ball holder as shown in FIG. 23, in which the axial pins on both hinge parts become a common axle of the hinge, see FIG. 24 also.

On the other hand, as further shown in FIG. 23, first closure element 430 and second closure element 430′ are aligned laterally with each other when the ball holder is closed, wherein the through-holes in the two closure elements are aligned to form a common through-hole for engaging with a releasable lock as described above.

Ball holder 400 has advantages of low cost manufacturing because both hemispherical shells in the ball holder can be produced by plastic molding using one single mold, as well as convenient assembling.

While the present invention has been described in detail and pictorially shown in the accompanying drawings, these should not be construed as limitations on the scope of the present invention, but rather as an exemplification of preferred embodiments thereof. It will be apparent, however, that various modifications and changes can be made within the spirit and the scope of this invention as described in the above specification and defined in the appended claims and their legal equivalents.

What is claimed is:

1. A ball holder comprising:
a first and a second hollow hemispherical shell of an equal diameter, each hemispherical shell having therein a plurality of apertures; the first hemispherical shell including a first hinge part disposed at a circumference thereof and, diametrically opposed therefrom, a first closure element; and the second hemispherical shell including a second hinge part at a circumference thereof attached to the first hinge part thereby enabling turning the first or the second hemispherical shell relative to each other to open or close the ball holder, and a second closure element disposed diametrically opposed from the second hinge part and in alignment with the first closure element when the ball holder is closed; and
a plurality of protuberances spaced apart along an internal surface of at least one of the hemispherical shells, the protuberances configured to form discrete contact points with a ball to be held in the ball holder and to separate the ball from the internal surface thereby reducing surface contact areas of the ball with the internal surface to facilitate drying the ball.

2. The ball holder of claim 1, wherein the protuberances have a height from about 1 to about 5 millimeters.

3. The ball holder of claim 1, wherein a ratio of a height of the protuberances to an inner diameter of the at least one hemispherical shell is less than 8%.

4. The ball holder of claim 1, wherein the plurality of protuberances are disposed circularly along the internal surface of the at least one hemispherical shell, and interval distances between one of the protuberances and the next are comparable among the plurality of protuberances to provide a balanced support of the ball to be held within the ball holder.

5. The ball holder of claim 1, wherein the protuberances are distanced from an axial center of the at least one hemispherical shell, with a radial distance from about 20% to about 70% of a radius of the hemispherical shell.

6. The ball holder of claim 1, wherein each hemispherical shell comprises the plurality of protuberances spaced apart along the internal surface of respective hemispherical shell.

7. The ball holder of claim 1, wherein the ball holder comprises at least three protuberances disposed circularly along the internal surfaces of hemispherical shells, and interval distances between one of the protuberances and the next are comparable among the at least three protuberances to provide a balanced support of the ball to be held within the ball holder.

8. The ball holder of claim 1, wherein an accumulated open area of the plurality of apertures in each hemispherical shell is from about 5% to about 75% of a total external surface area of each hemispherical shell.

9. The ball holder of claim 1, wherein each of the first and second closure elements is in a form of a tab extending from the circumference of respective hemispherical shell and with a through-hole; and when the ball holder is closed, the through-holes are aligned with each other forming a common through-hole.

10. The ball holder of claim 9, wherein the ball holder further includes a releasable lock attacked to the first and second closure elements through the common through-hole.

11. The ball holder of claim 1, wherein the first and second hinge parts are connected by a pin, or by a bolt and locknut connection.

12. A ball holder assembly comprising:
a ball holder comprising:
a first and a second hollow hemispherical shell of an equal diameter, each hemispherical shell having therein a plurality of apertures; the first hemispherical shell including a first hinge part disposed at a circumference thereof and, diametrically opposed therefrom, a first closure element; and the second hemispherical shell including a second hinge part at a circumference thereof attached to the first hinge part thereby enabling turning the first or the second hemispherical shell relative to each other to open or close the ball holder, and a second closure element disposed diametrically opposed from the second hinge part and in alignment with the first closure element when the ball holder is closed; and
a plurality of protuberances spaced apart along an internal surface of at least one of the hemispherical shells, the protuberances configured to form discrete contact points with a ball to be held in the ball holder and to separate the ball from the internal surface thereby reducing surface contact areas of the ball with the internal surface to facilitate drying the ball; and
a releasable lock attached to the ball holder through commonly aligned through-holes in the first and second closure elements.

13. The ball holder assembly of claim 12, wherein the protuberances have a height from about 1 to about 5 millimeters.

14. The ball holder assembly of claim 12, wherein a ratio of a height of the protuberances to an inner diameter of the at least one hemispherical shell is less than 8%.

15. The ball holder assembly of claim 12, wherein the plurality of protuberances are disposed circularly along the internal surface of the at least one hemispherical shell, and interval distances between one of the protuberances and the next are comparable among the plurality of protuberances to provide a balanced support of the ball to be held within the ball holder.

16. The ball holder assembly of claim 12, wherein the protuberances are distanced from an axial center of the at least one hemispherical shell, with a radial distance from about 20% to about 70% of a radius of the hemispherical shell

17. The ball holder assembly of claim 12, wherein each hemispherical shell comprises the plurality of protuberances spaced apart along the internal surface of respective hemispherical shell

18. The ball holder assembly of claim 12, wherein the ball holder comprises at least three protuberances disposed circularly along the internal surfaces of hemispherical shells, and interval distances between one of the protuberances and the next are comparable among the at least three protuberances to provide a balanced support of the ball to be held within the ball holder.

19. The ball holder assembly of claim 12 further comprising a ball within the ball holder.

20. The ball holder assembly of claim 19, wherein the ball comprises tennis ball, baseball, softball, golf ball, pin pong ball, rubber ball, or other balls.
